(19) United States
(12) Patent Application Publication
(10) Pub. No.: US 2013/0300527 A1
(43) Pub. Date: Nov. 14, 2013

(54) METHOD OF MANUFACTURING COIL ELEMENT AND COIL ELEMENT

(71) Applicant: SAMSUNG ELECTRO-MECHANICS CO., LTD., Suwon (KR)

(72) Inventors: Yong Suk KIM, Suwon-si (KR); Sung Kwon WI, Suwon-si (KR); Ju Hwan YANG, Suwon-si (KR); Won Chul SIM, Suwon-si (KR); Jeong Bok KWAK, Suwon-si (KR); Jeong Min CHO, Suwon-si (KR); Young Seuck YOO, Suwon-si (KR); Sang Moon LEE, Suwon-s (KR)

(73) Assignee: SAMSUNG ELECTRO-MECHANICS CO., LTD., Suwon (KR)

(21) Appl. No.: 13/801,264

(22) Filed: Mar. 13, 2013

(30) Foreign Application Priority Data
May 8, 2012 (KR) 10-2012-0048608

(51) Int. Cl. H01F 41/04; H01F 5/00

(52) U.S. Cl. CPC H01F 41/04; H01F 5/003
USPC 336/83; 29/605; 336/200

(57) ABSTRACT

The present invention relates to a method of manufacturing a coil element and a coil element, which include a process of forming, aligning, and coupling a first auxiliary layer and a second auxiliary layer of which coil portions formed of a plating pattern are disposed on a substrate or an insulating layer, and it is possible to overcome limitations due to collapse or deformation of a photoresist pattern even when forming a fine-pitch fine conductor coil with a high aspect ratio by applying a plating method using a photoresist pattern.

### CROSS-REFERENCE TO RELATED APPLICATIONS

Claim and incorporate by reference domestic priority application and foreign priority application as follows:

### CROSS REFERENCE TO RELATED APPLICATION

This application claims the benefit under 35 U.S.C. Section 119 of Korean Patent Application Serial No. 10-2012-0048608, entitled filed May 8, 2012, which is hereby incorporated by reference in its entirety into this application.

### BACKGROUND OF THE INVENTION

1. Field of the Invention

The present invention relates to a method of manufacturing a coil element and a coil element.

2. Description of the Related Art

In line with high speed and multifunction of electronic devices, there is an increasing demand for higher data transmission speed. Researches to improve functions of a common mode filter (CMF) for effectively removing common mode noise in this high speed data transmission interface have been competitively conducted.

Further, when considering the trend that a frequency band used for communication in electronic devices gradually moves to a high frequency band and miniaturization of the electronic devices is accelerating, a demand for miniaturization and high performance of the CMF, which is essentially employed in the electronic devices for communication, is also increasing.

Patent Document 1 discloses technologies related to a CMF and a method of manufacturing a CMF.

In the CMF in accordance with Patent Document 1, a non-magnetic insulator is formed between magnetic substances to increase common mode impedance, two layers of conductor coils and input/out lead terminal wires are formed inside the non-magnetic insulator, and an external electrode portion is formed so that the lead terminal wire is soldered on a circuit pattern of a substrate when the CMF is mounted on the substrate.

However, in the CMFs disclosed in Patent Document 1 and so on, since the entire intermediate layer of the CMF including a conductor coil portion between upper/lower magnetic substances is made of a non-magnetic insulator, there was a problem that a main magnetic flux loop of the CMP is suppressed.

Meanwhile, in some cases, it is needed to increase a height of the conductor coil portion and reduce a width thereof at the same time. In other words, it is needed to increase an aspect ratio of the conductor coil and form a fine-pitch fine conductor coil.

However, when forming a fine-pitch fine conductor coil with a high aspect ratio by a conventional plating method using a typical photoresist pattern, there were limitations in increasing an aspect ratio or forming a fine conductor coil due to collapse or deformation of the photoresist pattern.

### RELATED ART DOCUMENT

### Patent Document

Patent Document 1: Japanese Patent Laid-open Publication No. 2009-188111

### SUMMARY OF THE INVENTION

The present invention has been invented in order to overcome the above-described problems and it is, therefore, an object of the present invention to provide a method of manufacturing a coil element that is capable of increasing an aspect ratio of a plating pattern which constitutes a coil portion and achieving fine patterning of the plating pattern at the same time.

Further, it is another object of the present invention to provide a coil element with an increased aspect ratio and including a fine-pitch fine-patterned plating pattern.

In accordance with one aspect of the present invention to achieve the object, there is provided a method of manufacturing a coil element, including the steps of: forming a first auxiliary layer and a second auxiliary layer of which coil portions formed of a plating pattern are disposed on a substrate; aligning the first auxiliary layer and the second auxiliary layer so that an upper surface of the coil portion of the first auxiliary layer and an upper surface of the coil portion of the second auxiliary layer are adjacent to each other while facing each other; and forming a conductive coupling portion between the upper surface of the coil portion of the first auxiliary layer and the upper surface of the coil portion of the second auxiliary layer.

At this time, the first auxiliary layer and the second auxiliary layer may be formed by the steps of: forming a seed layer on the substrate; forming a photoresist pattern on a surface of the seed layer; forming a plating layer by plating the seed layer; removing the photoresist pattern; and forming the coil portion by removing a seed residue, a portion in which the plating layer is not formed, from the seed layer.

Further, the first auxiliary layer and the second auxiliary layer may be formed by the steps of: forming an insulating layer on the substrate; forming a seed layer on a surface of the insulating layer; forming a photoresist pattern on a surface of the seed layer; forming a plating layer by plating the seed layer; removing the photoresist pattern; and forming the coil portion by removing a seed residue, a portion in which the plating layer is not formed, from the seed layer.

Further, it is preferred that the conductive coupling portion is formed by an electroless plating method.

In accordance with another aspect of the present invention to achieve the object, there is provided a method of manufacturing a coil element, including the steps of: forming a first pattern layer by forming a first auxiliary layer and a second auxiliary layer of which coil portions formed of a plating pattern are disposed on a substrate, aligning the first auxiliary layer and the second auxiliary layer so that an upper surface of the coil portion of the first auxiliary layer and an upper surface of the coil portion of the second auxiliary layer are adjacent to each other while facing each other, forming a first conductive coupling portion between the upper surface of the coil portion of the first auxiliary layer and the upper surface of the coil portion of the second auxiliary layer, and removing the substrate of any one of the first auxiliary layer and the second auxiliary layer; forming a first insulating portion which covers the coil portion of the first pattern layer; forming a first seed portion on an upper surface of the first insulating portion; forming a photoresist pattern on a surface of the first seed portion; forming a first plating portion by plating the first seed portion; removing the photoresist pattern; forming a first additional coil portion by removing the exposed seed portion, a portion in which the first plating portion is not formed, from the first seed portion; forming a second additional auxiliary layer of which a coil portion formed of a plating pattern is disposed on a substrate; aligning the second additional auxiliary layer on the first additional coil portion so that an upper surface of the coil portion of the second additional auxiliary layer and an upper surface of the first additional coil portion are adjacent to each other while facing each other; forming a second pattern layer by forming a second conductive coupling portion between the upper surface of the first additional coil portion and the upper surface of the coil portion of the second additional auxiliary layer; removing a substrate of the second pattern layer; forming a second insulating portion which covers the coil portion of the second pattern layer; forming an external electrode on an upper surface of the second insulating portion; and forming a magnetic substance which covers the first insulating portion and the second insulating portion.

At this time, it is preferred that the conductive coupling portion is formed by an electroless plating method.

Further, it is preferred that the substrate is formed by sintering a soft magnetic material.

Further, the photoresist pattern may be formed using exposure and developing processes.

In accordance with still another aspect of the present invention to achieve the object, there is provided a method of manufacturing a coil element, including the steps of: forming a first pattern layer by forming a first auxiliary layer and a second auxiliary layer of which coil portions formed of a plating pattern are disposed on a substrate, aligning the first auxiliary layer and the second auxiliary layer so that an upper surface of the coil portion of the first auxiliary layer and an upper surface of the coil portion of the second auxiliary layer are adjacent to each other while facing each other, forming a first conductive coupling portion between the upper surface of the coil portion of the first auxiliary layer and the upper surface of the coil portion of the second auxiliary layer, and removing the substrate of any one of the first auxiliary layer and the second auxiliary layer; forming a second pattern layer by forming a first additional auxiliary layer and a second additional auxiliary layer of which coil portions formed of a plating pattern are disposed on a substrate, aligning the first additional auxiliary layer and the second additional auxiliary layer so that an upper surface of the coil portion of the first additional auxiliary layer and an upper surface of the coil portion of the second additional auxiliary layer are adjacent to each other while facing each other, forming a second conductive coupling portion between the upper surface of the coil portion of the first additional auxiliary layer and the upper surface of the coil portion of the second additional auxiliary layer, and removing the substrate of any one of the first additional auxiliary layer and the second additional auxiliary layer; forming a first insulating portion which covers the coil portion of the first pattern layer; coupling the second pattern layer so that the coil portion of the second pattern layer is in contact with an upper surface of the first insulating portion; removing the substrate of the second pattern layer; forming a second insulating portion which covers the coil portion of the second pattern layer; forming an external electrode on an upper surface of the second insulating portion; and forming a magnetic substance which covers the first insulating portion and the second insulating portion.

At this time, it is preferred that the conductive coupling portion is formed by an electroless plating method.

Further, it is preferred that the substrate is formed by sintering a soft magnetic material.

Further, the photoresist pattern may be formed using exposure and developing processes.

In accordance with still another aspect of the present invention to achieve the object, there is provided a coil element including: a first plating pattern formed on a substrate; a conductive coupling portion formed on an upper surface of the first plating pattern; and a second plating pattern formed on an upper surface of the conductive coupling portion.

At this time, the first plating pattern and the second plating pattern may be formed by electroplating, and the conductive coupling portion may be formed by electroless plating.

Further, the coil element may further include an insulating layer formed between the substrate and the first plating pattern.

In accordance with still another aspect of the present invention to achieve the object, there is provided a coil element including: a first plating pattern formed on a substrate; a first conductive coupling portion formed on an upper surface of the first plating pattern; a second plating pattern formed on an upper surface of the conductive coupling portion; a first insulating portion which covers the first plating pattern, the first conductive coupling portion, and the second plating pattern; a first additional plating pattern formed on an upper surface of the first insulating portion; a second conductive coupling portion formed on an upper surface of the first additional plating pattern; a second additional plating pattern formed on an upper surface of the second conductive coupling portion; a second insulating portion which covers the first additional plating pattern, the second conductive coupling portion, and the second additional plating pattern; an external electrode formed on an upper surface of the second insulating portion; and a magnetic substance which covers the first insulating portion and the second insulating portion and exposes at least one surface of the external electrode.

At this time, the first plating pattern, the second plating pattern, the first additional plating pattern, and the second additional plating pattern may be formed by electroplating, and the first conductive coupling portion and the second conductive coupling portion may be formed by electroless plating.

Further, the coil element may further include an insulating layer formed between the substrate and the first plating pattern.

Further, the magnetic substance may consist of a mixture of ferrite and resin.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIGS. 1a to 1g are views schematically showing a process of forming a first auxiliary layer in a method of manufacturing a coil element in accordance with an embodiment of the present invention, wherein

FIG. 1a schematically shows a process of providing a first substrate,

FIG. 1b schematically shows a process of forming a first insulating layer,

FIG. 1c schematically shows a process of forming a first seed layer,

FIG. 1d schematically shows a process of forming a first photoresist pattern,

FIG. 1e schematically shows a process of forming a first plating layer,

FIG. 1f schematically shows a process of removing the first photoresist pattern, and

FIG. 1g schematically shows a process of forming a first coil portion;

FIGS. 2a to 2d are views schematically showing a process of forming a first pattern layer in a method of manufacturing a coil element in accordance with an embodiment of the present invention, wherein

FIG. 2a schematically shows a process of providing a first auxiliary layer and a second auxiliary layer,

FIG. 2b schematically shows a process of aligning the first auxiliary layer and the second auxiliary layer,

FIG. 2c schematically shows a process of coupling the first auxiliary layer and the second auxiliary layer, and

FIG. 2d schematically shows a process of removing a first substrate and a first insulating layer or a second substrate and a second insulating layer;

FIG. 3a is a view schematically showing the planar shape of a first pattern layer in a method of manufacturing a coil element in accordance with an embodiment of the present invention;

FIG. 3b is a view schematically showing the planar shape of a second pattern layer in a method of manufacturing a coil element in accordance with an embodiment of the present invention;

FIG. 4 is a view schematically showing a method of manufacturing a coil element in accordance with an embodiment of the present invention;

FIGS. 5a to 5k are views schematically showing a method of manufacturing a coil element in accordance with an embodiment of the present invention, wherein

FIG. 5a schematically shows a process of providing a first auxiliary layer and a second auxiliary layer,

FIG. 5b schematically shows a process of forming a first pattern layer,

FIG. 5c schematically shows a process of forming a first insulating portion on the first pattern layer,

FIG. 5d schematically shows a process of forming a photoresist pattern,

FIG. 5e schematically shows a process of forming a first plating portion,

FIG. 5f schematically shows a process of removing the photoresist pattern,

FIG. 5g schematically shows a process of forming a first additional coil portion by removing an exposed seed portion,

FIG. 5h schematically shows a process of providing a second additional auxiliary layer,

FIG. 5i schematically shows a process of coupling the second additional auxiliary layer and the first additional coil portion,

FIG. 5j schematically shows a process of removing a fourth substrate and a fourth insulating layer, forming a second insulating portion, and forming an external electrode, and

FIG. 5k schematically shows a process of filling a magnetic substance;

FIG. 6 is a view schematically showing a method of manufacturing a coil element in accordance with an embodiment of the present invention; and

FIGS. 7a to 7h are views schematically showing a method of manufacturing a coil element in accordance with another embodiment of the present invention, wherein

FIG. 7a schematically shows a process of providing a first auxiliary layer and a second auxiliary layer,

FIG. 7b schematically shows a process of forming a first pattern layer,

FIG. 7c schematically shows a process of providing a first additional auxiliary layer and a second additional auxiliary layer,

FIG. 7d schematically shows a process of forming a second pattern layer,

FIG. 7e schematically shows a process of aligning the first pattern layer and the second pattern layer,

FIG. 7f schematically shows a process of coupling the first pattern layer and the second pattern layer,

FIG. 7g schematically shows a process of removing a substrate and an insulating layer of the second pattern layer, forming a second insulating portion, and forming an external electrode, and

FIG. 7h schematically shows a process of filling a magnetic substance.

### DETAILED DESCRIPTION OF THE PREFERABLE EMBODIMENTS

Advantages and features of the present invention and methods of accomplishing the same will be apparent by referring to embodiments described below in detail in connection with the accompanying drawings. However, the present invention is not limited to the embodiments disclosed below and may be implemented in various different forms. The embodiments are provided only for completing the disclosure of the present invention and for fully representing the scope of the present invention to those skilled in the art. Like reference numerals refer to like elements throughout the specification.

Terms used herein are provided to explain embodiments, not limiting the present invention. Throughout this specification, the singular form includes the plural form unless the context clearly indicates otherwise. When terms “comprises” and/or “comprising” used herein do not preclude existence and addition of another component, step, operation and/or device, in addition to the above-mentioned component, step, operation and/or device.

A method of manufacturing a coil element in accordance with an embodiment of the present invention includes a process of forming, aligning, and coupling a first auxiliary layer and a second auxiliary layer of which coil portions formed of a plating pattern is disposed on a substrate or an insulating layer.

At this time, the coil portions of the first auxiliary layer and the second auxiliary layer may be formed by an electroplating method, and a conductive coupling portion for electrically and physically coupling the coil portions of the first auxiliary layer and the second auxiliary layer may be formed by an electroless plating method.

The coil element including the first auxiliary layer and the second auxiliary layer formed like this, for example, may be implemented as a coil element in which a coil pattern with a high aspect ratio is formed on a single layer, and in this implementation process, an external terminal, a magnetic substance, a housing, and so on may be further provided.

Accordingly, even when a fine-pitch fine conductor coil with a high aspect ratio should be formed by a plating method using a photoresist pattern, it is possible to overcome limitations due to collapse or deformation of the photoresist pattern.

Hereinafter, configurations and operational effects of the present invention will be described in detail with reference to the accompanying drawings.

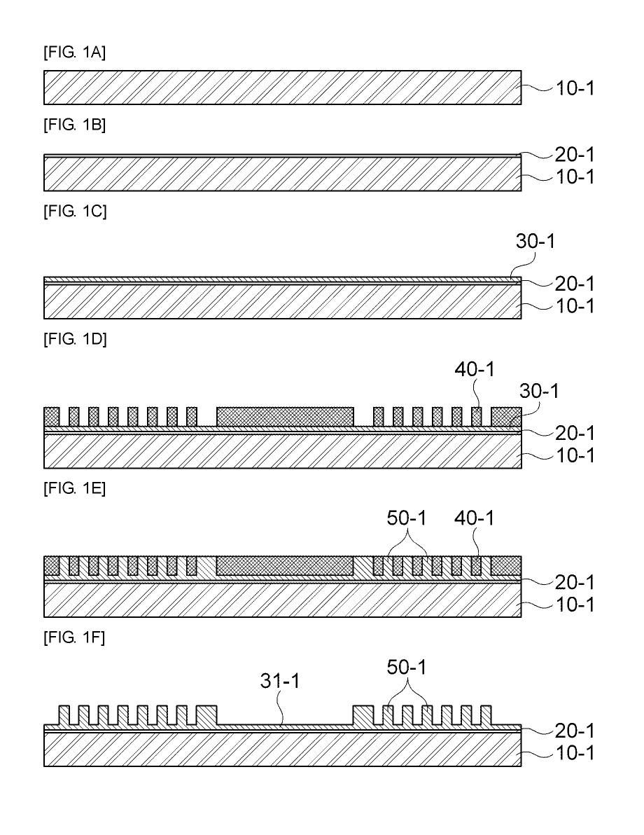

FIGS. 1a to 1g are views schematically showing a process of forming a first auxiliary layer in a method of manufacturing a coil element in accordance with an embodiment of the present invention.

First, FIG. 1a is a view schematically showing a process of providing a first substrate 10-1, FIG. 1b is a view schematically showing a process of forming a first insulating layer 20-1, and FIG. 1c is a view schematically showing a process of forming a first seed layer 30-1.

The first substrate 10-1 may be implemented with a common material used in a coil element. However, it is preferred that the first substrate 10-1 is implemented as a sintered substrate 10 or a polymer substrate 10 with soft magnetism so that a spin is disposed parallel to the direction of a magnetic field when a magnetic flux occurs.

Meanwhile, the first substrate 10-1 may be implemented with a material including a conductive material such as ferrite. When the conductive material is included like this, a current may flow between patterns, which should secure insulating properties, among first plating patterns 60a-1 formed on the first substrate 10-1.

In order to overcome this problem, the first seed layer 30-1 may be formed in a state in which the first insulating layer 20-1 is formed on the first substrate 10-1 first.

FIG. 1d is a view schematically showing a process of forming a first photoresist pattern 40-1. Although not shown, the first photoresist pattern 40-1 may be formed by applying a photosensitive polymer on a surface of the first seed layer 30-1, exposing a predetermined region to light using a predetermined mask, and removing the photosensitive polymer unexposed to light (negative photosensitive polymer) or the photosensitive polymer exposed to light (positive photosensitive polymer).

FIG. 1e is a view schematically showing a process of forming a first plating layer 50-1. The first plating layer 50-1 may be formed in a portion where the first photoresist pattern 40-1 is not formed, that is, in the exposed first seed layer 30-1 portion. At this time, the first plating layer 50-1 may be formed by an electroplating method.

FIG. 1f is a view schematically showing a process of removing the first photoresist pattern 40-1, and FIG. 1g is a view schematically showing a process of forming a first coil portion 60-1. A first plating pattern 60a-1 is completed by removing the first photoresist pattern 40-1 with a chemical or physical method and removing a first seed residue (31-1) which is the first seed layer 30-1 positioned under a photoresist pattern 140, and the first coil portion 60-1 formed of the first plating pattern 60a-1 is formed.

Meanwhile, although FIGS. 1a to 1g show only the process of forming the first auxiliary layer, a second auxiliary layer can be formed by a method similar to that of the first auxiliary layer.

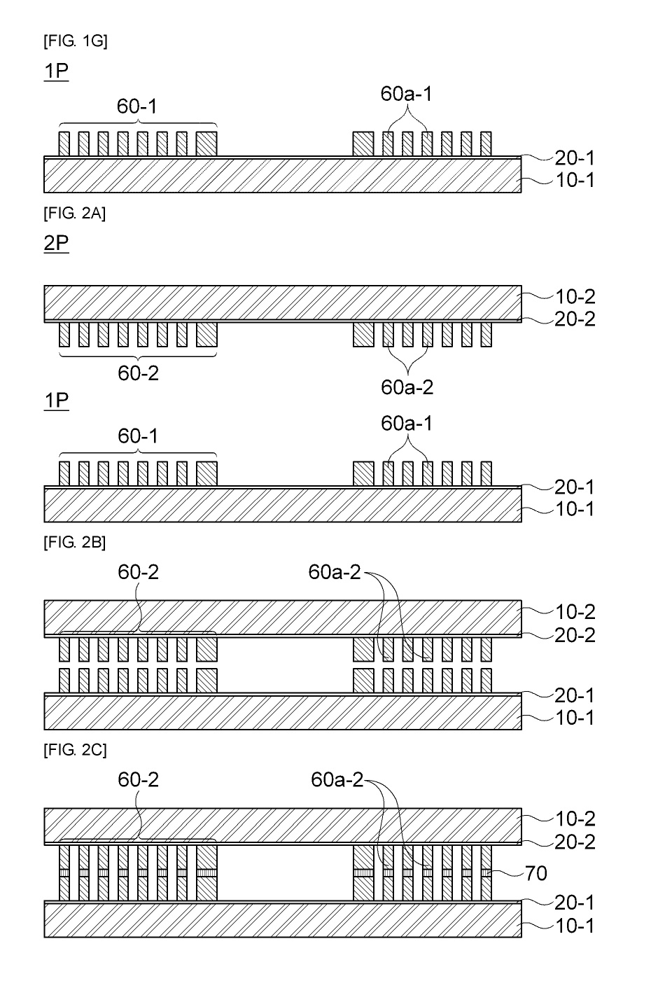

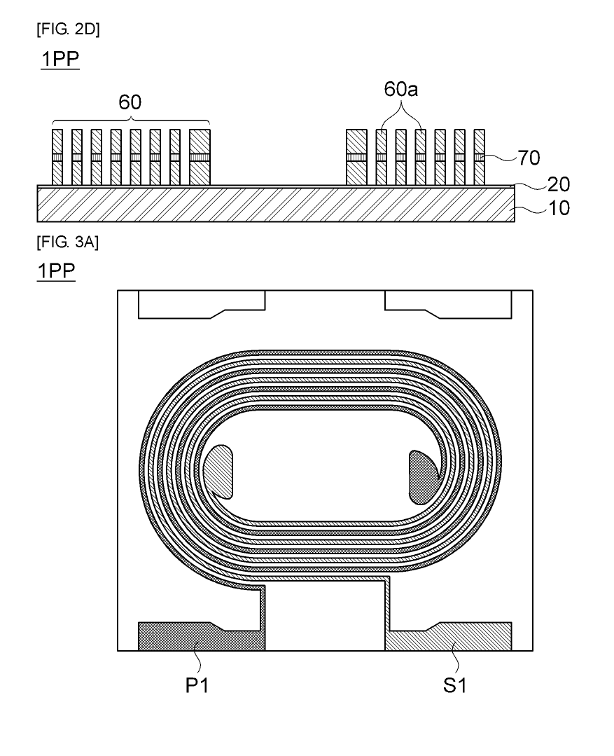

FIGS. 2a to 2d are views schematically showing a process of forming a first pattern layer 1PP in a method of manufacturing a coil element in accordance with the present invention. FIG. 2a schematically shows a process of providing a first auxiliary layer and a second auxiliary layer, FIG. 2b schematically shows a process of aligning the first auxiliary layer and the second auxiliary layer, FIG. 2c schematically shows a process of coupling the first auxiliary layer and the second auxiliary layer, and FIG. 2d schematically shows a process of removing a first substrate 10-1 and a first insulating layer 20-1 or a second substrate 10-2 and a second insulating layer 20-2.

Referring to FIGS. 2a to 2d, the first auxiliary layer and the second auxiliary layer are prepared and then aligned. At this time, the first auxiliary layer and the second auxiliary layer are aligned and fixed so that an upper surface of a coil portion 60-1 and an upper surface of a second coil portion 60-2 face each other and a first conductive coupling portion 70 is formed between the upper surface of the first coil portion 60-1 and the upper surface of the second coil portion 60-2 by a plating method.

Next, the first conductive coupling portion 70 is formed between the upper surface of the first coil portion 60-1 and the upper surface of the second coil portion 60-2 by a plating method.

At this time, when forming the first conductive coupling portion 70 using a mechanical plating method, it is preferred to apply an electroless plating method, that is, a chemical plating method since deviations such as adhesive strength, thickness, shape, and alignment may occur according to the state of contact surfaces to be connected.

In a state in which the first auxiliary layer and a second auxiliary layer are coupled like this, a coil element of which a coil portion 60 is implemented as a single layer may be manufactured by coating an insulating material on the surface of the first coil portion 60-1, the second coil portion 60-2, and the first conductive coupling portion 70 and filling a magnetic substance 90.

Further, a coil element shown in FIG. 2c may be used in manufacturing a coil element of which a coil portion 60 is formed in a plurality of layers. That is, it is especially advantageous when the required characteristics of the coil element, such as inductance and coupling coefficient, are not satisfied.

Referring to FIG. 2d, it is possible to understand that the first pattern layer 1PP is formed by removing any one substrate 10 and insulating layer 20 selected from the first substrate 10-1 and the first insulating layer 20-1 or the second substrate 10-2 and the second insulating layer 20-2.

When forming the first pattern layer 1PP like this, efficiency of a process of forming an insulating portion which covers the coil portion 60 is improved, and it is more advantageous in providing an external electrode OT and the magnetic substance 90.

Especially, a coil element of which a coil portion 60 is formed in a plurality of layers can be manufactured by laminating the first pattern layer 1PP and a second pattern layer 2SP that can be manufactured by a method similar to that of the first pattern layer 1PP.

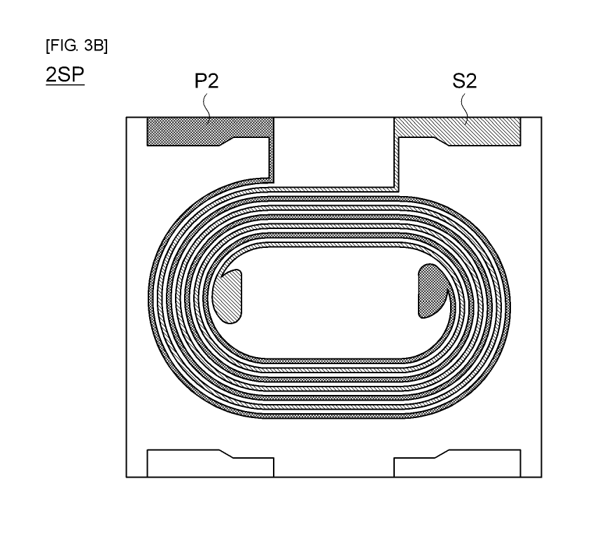

FIG. 3a is a view schematically showing the planar shape of the first pattern layer 1PP in a method of manufacturing a coil element in accordance with an embodiment of the present invention, and FIG. 3b is a view schematically showing the planar shape of the second pattern layer 2SP in a method of manufacturing a coil element in accordance with an embodiment of the present invention.

Referring to FIGS. 3a and 3b, the above-described first pattern layer 1PP may have a shape in which a first primary coil P1 and a first secondary coil S1 are wound while maintaining a predetermined interval. The above-described second pattern layer 2SP may have a shape in which a second primary coil P2 and a second secondary coil S2 are wound while maintaining a predetermined interval.

Further, it is possible to understand that a coil element with a plurality of layers of coil portions 60 can be manufactured by electrically connecting terminal portions formed inside the first primary coil P1 and the second secondary coil S2 through a via and so on and equally configuring the first secondary coil S1 and the second secondary coil S2 as well.

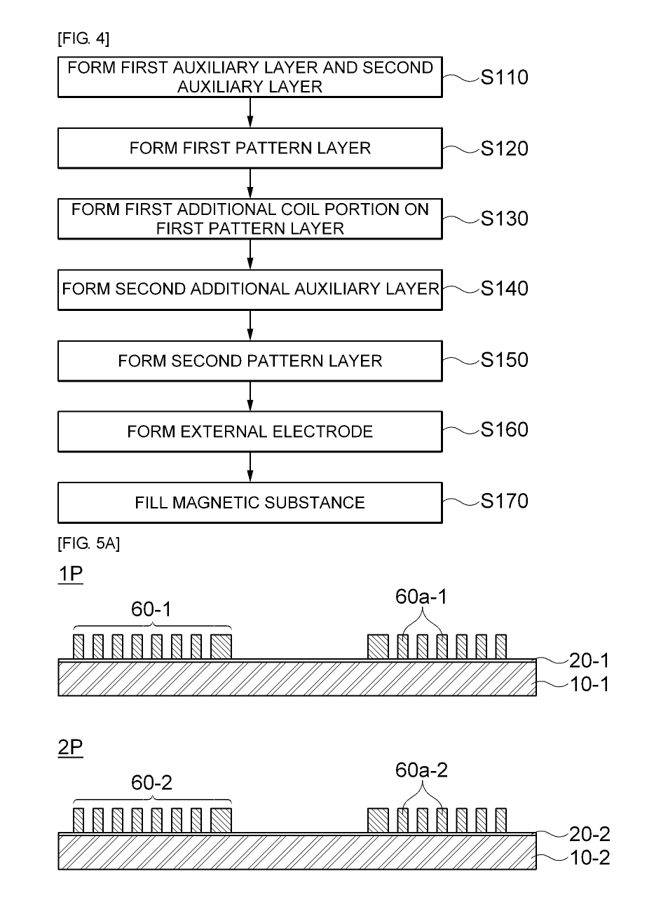

FIG. 4 is a view schematically showing a method of manufacturing a coil element in accordance with an embodiment of the present invention.

Referring to FIG. 4, a first auxiliary layer and a second auxiliary layer are formed (S110), and a first pattern layer 1PP is formed by coupling the first auxiliary layer and the second auxiliary layer (S120).

Next, a first additional coil portion 1S is formed on the first pattern layer 1PP (S130), and a second pattern layer 2SP is formed (S150) by coupling a separately prepared second additional auxiliary layer 2S on the first additional coil portion 1S (S140).

Next, a coil element is implemented by forming an external electrode OT (S160) and filling a magnetic substance 90 (S170).

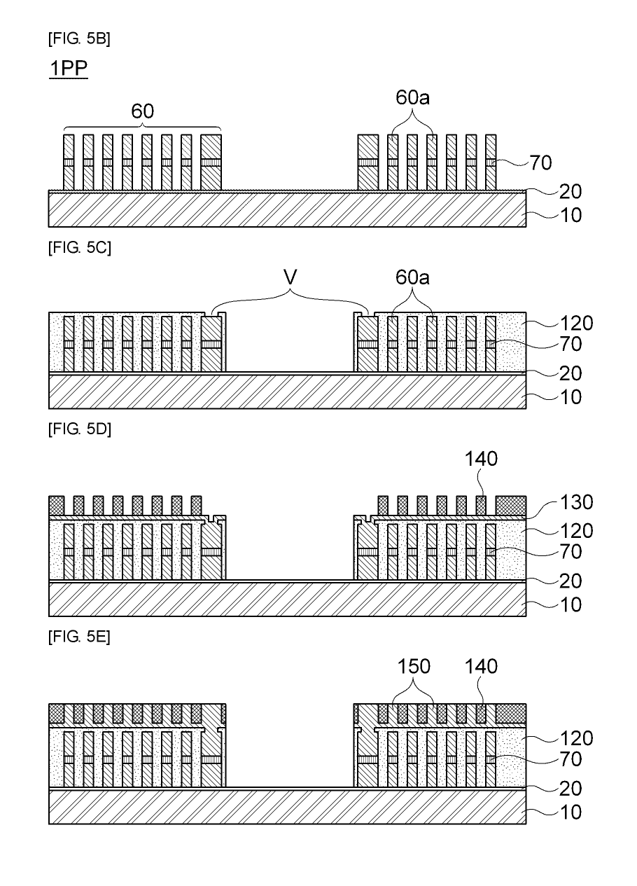

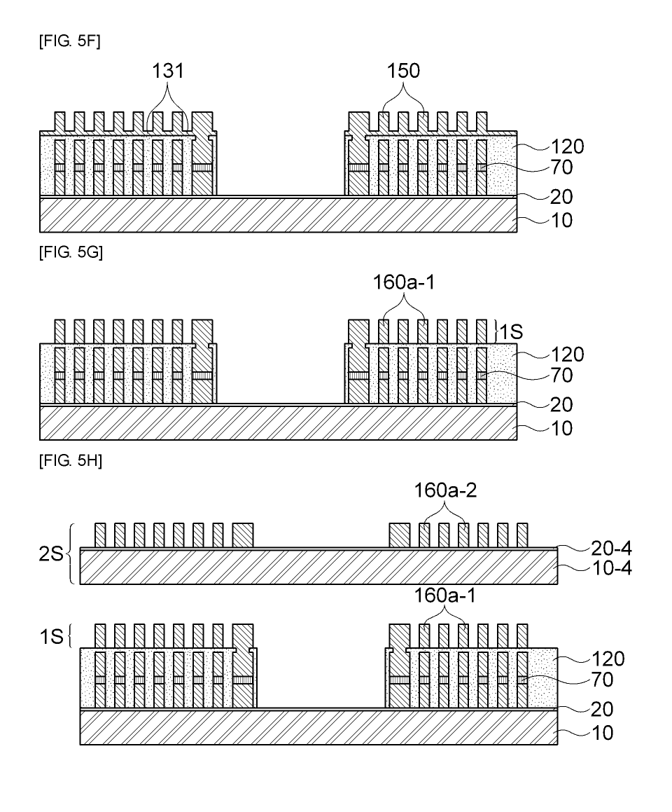

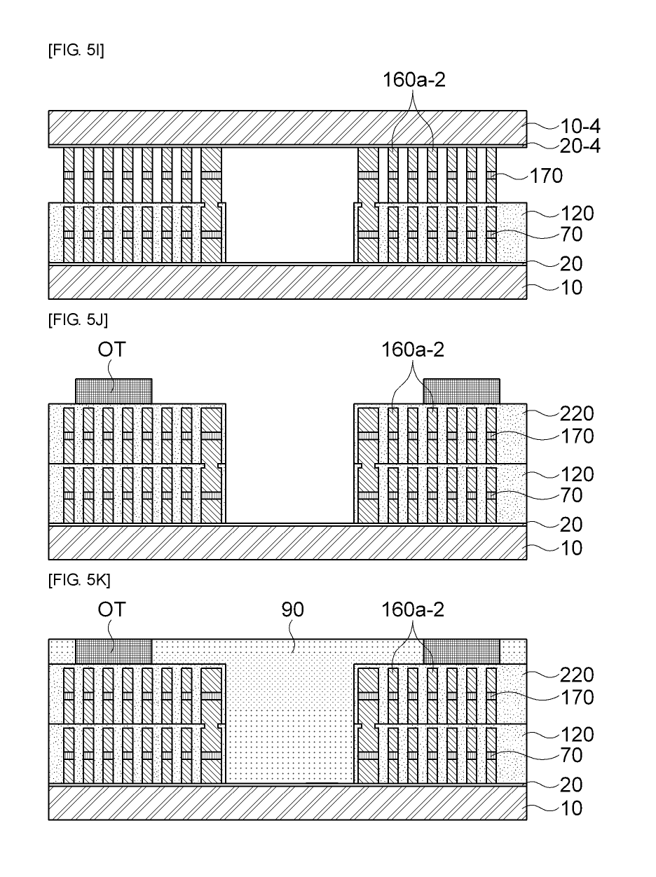

FIGS. 5a to 5k are views schematically showing a method of manufacturing a coil element in accordance with an embodiment of the present invention. Hereinafter, a method of manufacturing a coil element will be described with reference to FIGS. 5a to 5k.

FIG. 5a is a view schematically showing a process of providing a first auxiliary layer and a second auxiliary layer, and FIG. 5b is a view schematically showing a process of forming a first pattern layer 1PP.

Since the process of forming the first auxiliary layer and the second auxiliary layer and the process of forming the first pattern layer 1PP by coupling the first auxiliary layer and the second auxiliary layer are described above, repeated descriptions will be omitted.

FIG. 5c schematically shows a process of forming a first insulating portion 120 on the first pattern layer 1PP. As shown, the first insulating portion 120 may be formed to cover a coil portion 60 of the first pattern layer 1PP. At this time, it is preferred that a through-hole V is formed in an upper surface of at least one plating pattern 60a of the coil portion 60 of the first pattern layer 1PP to be electrically connected to a first additional coil portion 1S which will be described later.

FIG. 5d schematically shows a process of forming a photoresist pattern 140, FIG. 5e schematically shows a process of forming a first plating portion 150, FIG. 5f schematically shows a process of removing the photoresist pattern 140, and FIG. 5g schematically shows a process of forming the first additional coil portion 1S by removing an exposed seed portion.

Referring to FIGS. 5d to 5g, the photoresist pattern 140 is formed by forming a first seed portion 130 on the first insulating portion 120, applying a photosensitive polymer, and performing exposure and developing processes.

Next, the first additional coil portion 1S, which is formed of a first additional plating pattern 160a-1, is formed by removing the photoresist pattern 140 and the exposed seed portion after forming the first plating portion 150 on the exposed first seed portion 130.

At this time, at least one plating pattern 60a of the coil portion 60 of the first pattern layer 1PP can be electrically connected to the first additional plating pattern 160a-1 through the through-hole V formed in the first insulating portion 120.

FIG. 5h schematically shows a process of providing a second additional auxiliary layer 2S, and FIG. 5i schematically shows a process of coupling the second additional auxiliary layer 2S and the first additional coupling portion 1S.

Referring to FIGS. 5h and 5i, the second additional auxiliary layer 2S is provided to be coupled with the first additional coil portion 1S.

At this time, the second additional auxiliary layer 2S can be manufactured by the same method as the above-described first auxiliary layer.

Further, an upper surface of a second additional plating pattern 160a-2 of the second additional auxiliary layer 2S and an upper surface of the first additional coil portion 1S are aligned to be adjacent to each other while facing each other, and a second conductive coupling portion 170 is formed between the upper surface of the second additional plating pattern 160a-2 and the upper surface of the first additional coil portion 1S to connect them.

FIG. 5j schematically shows a process of removing a fourth substrate 10-4 and a fourth insulating layer 20-4, forming a second insulating portion 220, and forming an external electrode OT, and FIG. 5k schematically shows a process of filling a magnetic substance 90.

Referring to FIGS. 5j and 5k, after the fourth substrate 10-4 and the fourth insulating layer 20-4 of the second additional auxiliary layer 2S are removed, the second insulating portion 220 is formed to cover the second additional plating pattern 160a-2, the second conductive coupling portion 170, and the first additional coil portion 1S.

Next, a coil element can be manufactured by forming the external electrode OT on the second insulating portion 220 and filling the magnetic substance 90.

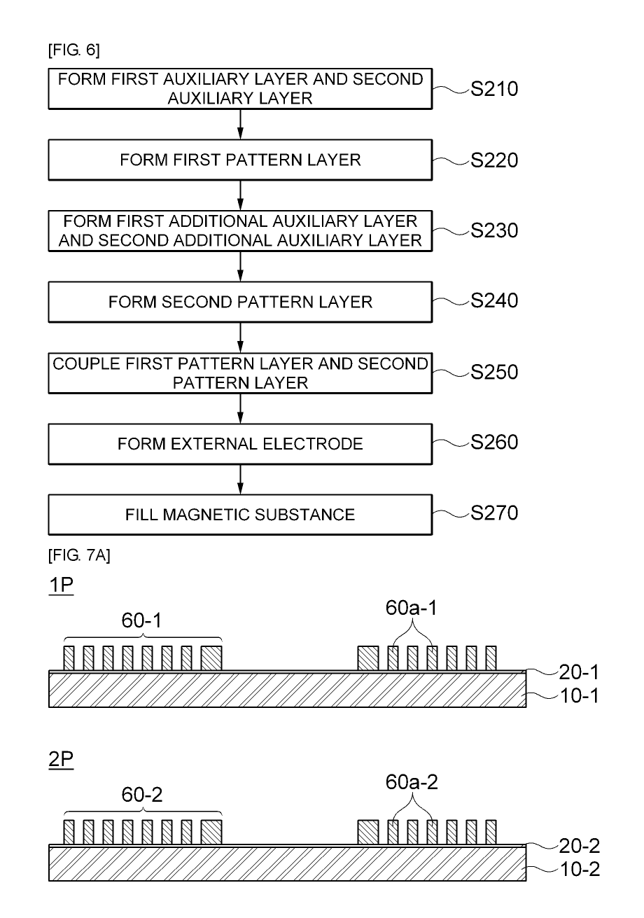

FIG. 6 is a view schematically showing a method of manufacturing a coil element in accordance with an embodiment of the present invention.

Referring to FIG. 6, first, a first auxiliary layer and a second auxiliary layer are formed (S210), and a first pattern layer 1PP is formed by coupling the first auxiliary layer and the second auxiliary layer (S220). A second pattern layer 2SP is formed (S240) by forming a first additional auxiliary layer 1S′ and a second additional auxiliary layer 2S with the same method (S230) and coupling them.

Next, a coil element can be implemented by coupling the first pattern layer 1PP and the second pattern layer 2SP (S250), forming an external electrode OT (S260), and filling a magnetic substance (S270).

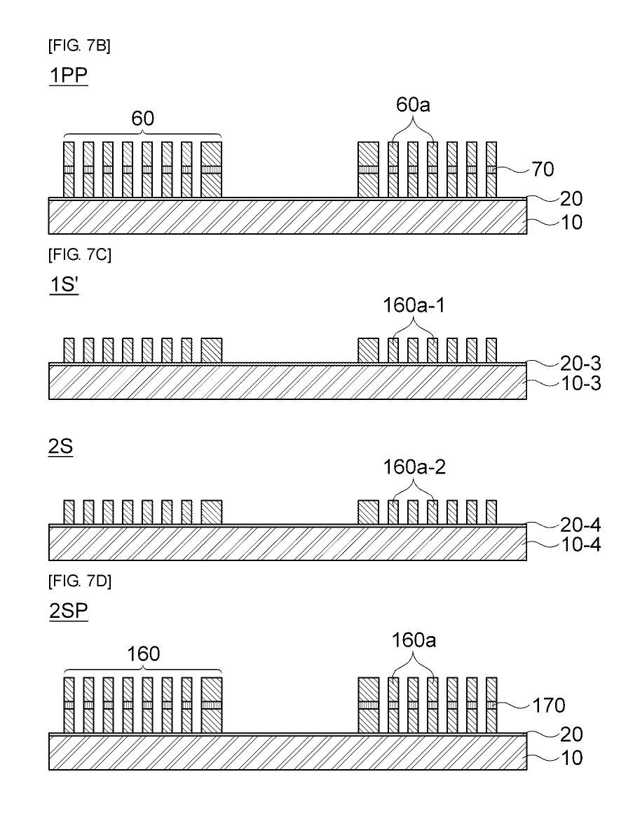

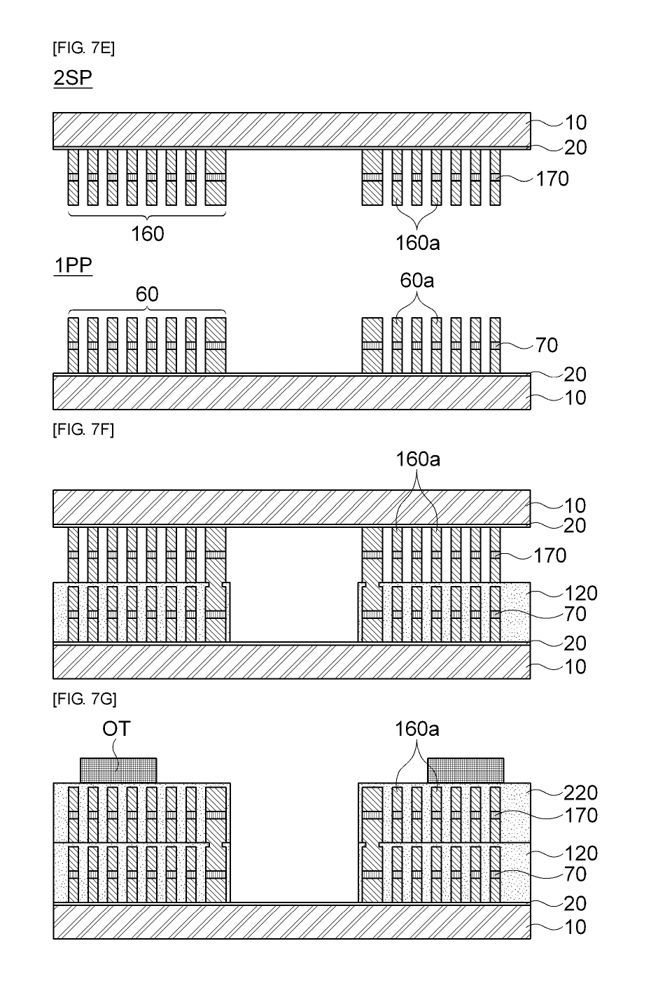

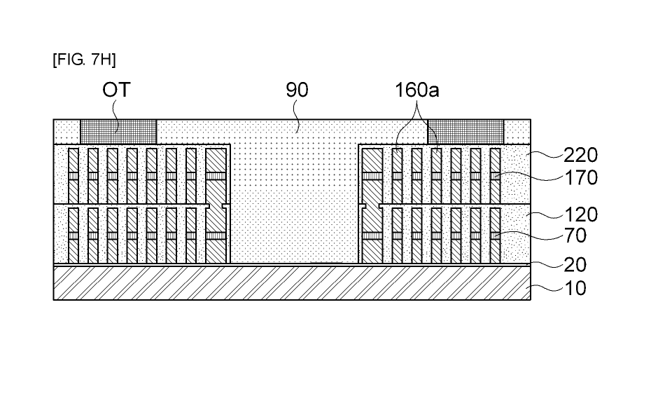

FIGS. 7a to 7h are views schematically showing a method of manufacturing a coil element in accordance with another embodiment of the present invention. Hereinafter, a method of manufacturing a coil element in accordance with an embodiment of the present invention will be described with reference to FIGS. 7a to 7h.

FIG. 7a is a view schematically showing a process of providing a first auxiliary layer and a second auxiliary layer, FIG. 7b is a view schematically showing a process of forming a first pattern layer 1PP, FIG. 7c is a view schematically showing a process of providing a first additional auxiliary layer 1S′ and a second additional auxiliary layer 2S, and FIG. 7d is a view schematically showing a process of forming a second pattern layer 2SP.

Since the process of forming the first auxiliary layer and the second auxiliary layer, the process of forming the first pattern layer 1PP by coupling the first auxiliary layer and the second auxiliary layer, the process of forming the first additional auxiliary layer 1S′ and the second additional auxiliary layer 2S, and the process of forming the first pattern layer 2SP by coupling the first additional auxiliary layer 1S′ and the second additional auxiliary layer 2S are described above, repeated descriptions will be omitted.

FIG. 7e schematically shows a process of aligning the first pattern layer 1PP and the second pattern layer 2SP, and FIG. 7f schematically shows a process of coupling the first pattern layer 1PP and the second pattern layer 2SP.

First, a first insulating portion 120 is formed to cover a coil portion 60 of the first pattern layer 1PP. At this time, it is preferred that a through-hole is formed in an upper surface of at least one plating pattern 60a of the coil portion 60 of the first pattern layer 1PP to be electrically connected to an additional plating pattern 160a of an additional coil portion 160 of the second pattern layer 2SP.

FIG. 7g schematically shows a process of removing a substrate 10 and an insulating layer 20 of the second pattern layer 2SP, forming a second insulating portion 220, and forming an external electrode OT, and FIG. 7h schematically shows a process of filling a magnetic substance 90.

Referring to FIGS. 7g and 7h, first, after the substrate 10 and the insulating layer 20 of the second pattern layer 2SP are removed, the second insulating portion 220 is formed to cover the additional coil portion of the second pattern layer 2SP.

Next, a coil element is manufactured by forming the external electrode OT on the second insulating portion 220 and filling the magnetic substance 90.

Accordingly, even when forming a fine-pitch fine conductor coil with a high aspect ratio by applying a plating method using a photoresist pattern 140, it is possible to overcome limitations due to collapse or deformation of the photoresist pattern 140.

Referring to FIGS. 2a and 2d, a coil element in accordance with an embodiment of the present invention may include a first plating pattern 60a-1 formed on a substrate 10; a conductive coupling portion formed on an upper surface of the first plating pattern 60a-1; and a second plating pattern 60a-2 formed on an upper surface of the conductive coupling portion.

At this time, the first plating pattern 60a-1 and the second plating pattern 60a-2 may be formed by electroplating, and the conductive coupling portion may be formed by electroless plating.

Further, an insulating layer 20 may be further formed between the substrate 10 and the first plating pattern 60a-1.

Referring to FIG. 7h, a coil element in accordance with an embodiment of the present invention may include a first plating pattern 60a-1 formed on a substrate 10; a first conductive coupling portion 70 formed on an upper surface of the first plating pattern 60a-1; a second plating pattern 60a-2 formed on an upper surface of the conductive coupling portion; a first insulating portion 120 which covers the first plating pattern 60a-1, the first conductive coupling portion 70, and the second plating pattern 60a-2; a first additional plating pattern 160a-1 formed on an upper surface of the first insulating portion 120; a second conductive coupling portion 170 formed on an upper surface of the first additional plating pattern 160a-1; a second additional plating pattern 160a-2 formed on an upper surface of the second conductive coupling portion 170; a second insulating portion 220 which covers the first additional plating pattern 160a-1, the second conductive coupling portion 170, and the second additional plating pattern 160a-2; an external electrode OT formed on an upper surface of the second insulating portion 220; and a magnetic substance 90 which covers the first insulating portion 120 and the second insulating portion 220 and exposes at least one surface of the external electrode OT.

At this time, the first plating pattern 60a-1, the second plating pattern 60a-2, the first additional plating pattern 160a-1, and the second additional plating pattern 160a-2 may be formed by electroplating, and the first conductive coupling portion 70 and the second conductive coupling portion 170 may be formed by electroless plating.

Further, an insulating layer 20 may be further formed between the substrate 10 and the first plating pattern 60a-1.

Further, the magnetic substance 90 may consist of a mixture of ferrite and resin.

The present invention configured as above can provide a coil element formed of a fine-pitch fine thick film pattern with a high aspect ratio and a method of manufacturing the same.

Further, it is possible to secure excellent plating with an external electrode due to excellent adhesion and connectivity of a plating pattern and improve characteristics such as impedance, inductance, and magnetic coupling coefficient required for a coil element by making the plating pattern more uniform and thicker than before.

Further, it is possible to reduce deviations due to various chemicals put into exposure and developing processes or a plating process by improving connectivity between the plating patterns.

Further, it is possible to reduce an interlayer parasitic component by implementing a fine-pitch fine plating pattern in a plurality of layers, thereby reducing insertion loss.

The foregoing description illustrates the present invention. Additionally, the foregoing description shows and explains only the preferred embodiments of the present invention, but it is to be understood that the present invention is capable of use in various other combinations, modifications, and environments and is capable of changes and modifications within the scope of the inventive concept as expressed herein, commensurate with the above teachings and/or the skill or knowledge of the related art. The embodiments described hereinabove are further intended to explain best modes known of practicing the invention and to enable others skilled in the art to utilize the invention in such, or other, embodiments and with the various modifications required by the particular applications or uses of the invention. Accordingly, the description is not intended to limit the invention to the form disclosed herein. Also, it is intended that the appended claims be construed to include alternative embodiments.

What is claimed is:

1. A method of manufacturing a coil element, comprising:
forming a first auxiliary layer and a second auxiliary layer of which coil portions formed of a plating pattern are disposed on a substrate;
aligning the first auxiliary layer and the second auxiliary layer so that an upper surface of the coil portion of the first auxiliary layer and an upper surface of the coil portion of the second auxiliary layer are adjacent to each other while facing each other; and
forming a conductive coupling portion between the upper surface of the coil portion of the first auxiliary layer and the upper surface of the coil portion of the second auxiliary layer.

2. The method of manufacturing a coil element according to claim 1, wherein the first auxiliary layer and the second auxiliary layer are formed by comprising:
forming a seed layer on the substrate;
forming a photoresist pattern on a surface of the seed layer;
forming a plating layer by plating the seed layer;
removing the photoresist pattern; and
forming the coil portion by removing a seed residue, a portion in which the plating layer is not formed, from the seed layer.

3. The method of manufacturing a coil element according to claim 1, wherein the first auxiliary layer and the second auxiliary layer are formed by comprising:
forming an insulating layer on the substrate;
forming a seed layer on a surface of the insulating layer;
forming a photoresist pattern on a surface of the seed layer;
forming a plating layer by plating the seed layer;
removing the photoresist pattern; and
forming the coil portion by removing a seed residue, a portion in which the plating layer is not formed, from the seed layer.

4. The method of manufacturing a coil element according to claim 1, wherein the conductive coupling portion is formed by an electroless plating method.

5. A method of manufacturing a coil element, comprising:
forming a first pattern layer by forming a first auxiliary layer and a second auxiliary layer of which coil portions formed of a plating pattern are disposed on a substrate, aligning the first auxiliary layer and the second auxiliary layer so that an upper surface of the coil portion of the first auxiliary layer and an upper surface of the coil portion of the second auxiliary layer are adjacent to each other while facing each other, forming a first conductive coupling portion between the upper surface of the coil portion of the first auxiliary layer and the upper surface of the coil portion of the second auxiliary layer, and removing the substrate of any one of the first auxiliary layer and the second auxiliary layer;
forming a first insulating portion which covers a coil portion of the first pattern layer;
forming a first seed portion on an upper surface of the first insulating portion;
forming a photoresist pattern on a surface of the first seed portion;
forming a first plating portion by plating the first seed portion;
removing the photoresist pattern;
forming a first additional coil portion by removing the exposed seed portion, a portion in which the first plating portion is not formed, from the first seed portion;
forming a second additional auxiliary layer of which a coil portion formed of a plating pattern is disposed on a substrate;
aligning the second additional auxiliary layer on the first additional coil portion so that an upper surface of the coil portion of the second additional auxiliary layer and an upper surface of the first additional coil portion are adjacent to each other while facing each other;
forming a second pattern layer by forming a second conductive coupling portion between the upper surface of the first additional coil portion and the upper surface of the coil portion of the second additional auxiliary layer;
removing a substrate of the second pattern layer;
forming a second insulating portion which covers the coil portion of the second pattern layer;
forming an external electrode on an upper surface of the second insulating portion; and
forming a magnetic substance which covers the first insulating portion and the second insulating portion.

6. The method of manufacturing a coil element according to claim 5, wherein the conductive coupling portion is formed by an electroless plating method.

7. The method of manufacturing a coil element according to claim 5, wherein the substrate is formed by sintering a soft magnetic material.

8. The method of manufacturing a coil element according to claim 5, wherein the photoresist pattern is formed using exposure and developing processes.

9. A method of manufacturing a coil element, comprising:
forming a first pattern layer by forming a first auxiliary layer and a second auxiliary layer of which coil portions formed of a plating pattern are disposed on a substrate, aligning the first auxiliary layer and the second auxiliary layer so that an upper surface of the coil portion of the first auxiliary layer and an upper surface of the coil portion of the second auxiliary layer are adjacent to each other while facing each other, forming a first conductive coupling portion between the upper surface of the coil portion of the first auxiliary layer and the upper surface of the coil portion of the second auxiliary layer, and removing the substrate of any one of the first auxiliary layer and the second auxiliary layer;
forming a second pattern layer by forming a first additional auxiliary layer and a second additional auxiliary layer of which coil portions formed of a plating pattern are disposed on a substrate, aligning the first additional auxiliary layer and the second additional auxiliary layer so that an upper surface of the coil portion of the first additional auxiliary layer and an upper surface of the coil portion of the second additional auxiliary layer are adjacent to each other while facing each other, forming a second conductive coupling portion between the upper surface of the coil portion of the first additional auxiliary layer and the upper surface of the coil portion of the second additional auxiliary layer, and removing the substrate of any one of the first additional auxiliary layer and the second additional auxiliary layer;
forming a first insulating portion which covers the coil portion of the first pattern layer;
coupling the second pattern layer so that the coil portion of the second pattern layer is in contact with an upper surface of the first insulating portion;
removing the substrate of the second pattern layer;
forming a second insulating portion which covers the coil portion of the second pattern layer;
forming an external electrode on an upper surface of the second insulating portion; and
forming a magnetic substance which covers the first insulating portion and the second insulating portion.

10. The method of manufacturing a coil element according to claim 9, wherein the conductive coupling portion is formed by an electroless plating method.

11. The method of manufacturing a coil element according to claim 9, wherein the substrate is formed by sintering a soft magnetic material.

12. The method of manufacturing a coil element according to claim 9, wherein the photoresist pattern is formed using exposure and developing processes.

13. A coil element comprising:
a first plating pattern formed on a substrate;
a conductive coupling portion formed on an upper surface of the first plating pattern; and
a second plating pattern formed on an upper surface of the conductive coupling portion.

14. The coil element according to claim 13, wherein the first plating pattern and the second plating pattern are formed by electroplating, and the conductive coupling portion is formed by electroless plating.

15. The coil element according to claim 13, further comprising:
an insulating layer formed between the substrate and the first plating pattern.

16. A coil element comprising:
a first plating pattern formed on a substrate;
a first conductive coupling portion formed on an upper surface of the first plating pattern;
a second plating pattern formed on an upper surface of the conductive coupling portion;
a first insulating portion which covers the first plating pattern, the first conductive coupling portion, and the second plating pattern;
a first additional plating pattern formed on an upper surface of the first insulating portion;
a second conductive coupling portion formed on an upper surface of the first additional plating pattern;
a second additional plating pattern formed on an upper surface of the second conductive coupling portion;
a second insulating portion which covers the first additional plating pattern, the second conductive coupling portion, and the second additional plating pattern;
an external electrode formed on an upper surface of the second insulating portion; and
a magnetic substance which covers the first insulating portion and the second insulating portion and exposes at least one surface of the external electrode.

17. The coil element according to claim 16, wherein the first plating pattern, the second plating pattern, the first additional plating pattern, and the second additional plating pattern are formed by electroplating, and
the first conductive coupling portion and the second conductive coupling portion are formed by electroless plating.

18. The coil element according to claim 16, further comprising:
an insulating layer formed between the substrate and the first plating pattern.

19. The coil element according to claim 16, wherein the magnetic substance consists of a mixture of ferrite and resin.
